(19) United States
(12) Patent Application Publication
(10) Pub. No.: US 2007/0258571 A1
(43) Pub. Date: Nov. 8, 2007

(54) Conference System

(76) Inventor: Achim Gleissner, Diekholzen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/590,984

(22) PCT Filed: Feb. 28, 2005
(86) PCT No.: PCT/EP05/50835

§ 371 Date: Apr. 25, 2007

(30) Foreign Application Priority Data
Feb. 26, 2004 (DE) 2004 009 314.8

(51) Int. Cl. H04M 3/42

(52) U.S. Cl. 379/202.01

(57) ABSTRACT

There is proposed a conference speech station for a conference system, which has an audio unit for changing audio signals into first signals, a signal processing unit further converts the first signals into second signals and an interface sends the second signals to an external network unit. A conference speech station of that kind is found to be advantageous insofar as it is less expensive to produce and also is of a simpler configuration as it does not have any network unit which is employed for communication with the conference network.

### CROSS-REFERENCE TO RELATED APPLICATIONS

This application claims priority of International Application No. PCT/EP2005/050835, filed Feb. 28, 2005 and German Application No. 10 2004 009 314.8, filed Feb. 26, 2004, the complete disclosures of which are hereby incorporated by reference.

### BACKGROUND OF THE INVENTION

a) Field of the Invention

The invention concerns a conference system and a conference speech station for such a conference system.

b) Description of the Related Art

Conference systems such as for example the SDC 8000 conference system from Sennheiser or the MCW-D-200 wireless conference system from Beyerdynamic are known, which can be operated both on a wired and also a wireless basis. In that case delegate speech stations, a chairman speech station and possibly interpreter speech stations are connected together by way of their own special bus system. Such speech stations typically have a microphone, a loudspeaker and a plurality of operating elements such as for example an operating element for selecting the channel, a selector button, a button for switching the microphone on/off and an insert slot for a chip card. Chip cards of that kind are used for personalization of the speech station. The speech station also has an interface for the bus system of the conference system. The speech station is usually implemented in a housing so that both the microphone/loudspeaker and the interface of the speech station are arranged in the same housing. In that case personalization and encryption are effected in the respective speech stations.

Some conference systems also afford the possibility that in particular mobile computers can be connected to the conference system. In that case data transfer between those computers is effected however by way of a separate network in the conference system and not by way of the special bus system of the speech stations.

In addition computer networks such as for example IP-based networks, LANs, WLANs and so forth are known, by which mobile computers or mobile terminals can be connected together and thus enable audio transmission insofar as the respective mobile computers or mobile terminals have an audio unit with a microphone and a loudspeaker. Networks of that kind can be both wired and also wireless.

In the case of conventional conference systems it is found to be disadvantageous that the bus systems used are not standardized but are only of a proprietary character. If moreover mobile terminals or mobile computers are to be connected to such a conference system, a further separate computer network has to be provided. In addition the audio components on mobile computers or mobile terminals do not have a satisfactory audio quality for applications such as a conference system.

### OBJECT AND SUMMARY OF THE INVENTION

Therefore the primary object of the present invention is to provide a conference system and conference speech stations which can be universally employed and which guarantee an adequate audio quality.

That object is attained by a conference installation in accordance with the invention comprising a network, a plurality of network units connected by the network, at least one delegate speech station which has an audio unit for changing audio signals into first signals, a signal processing unit for converting first signals into second signals, and an interface for sending the second signals to an external network and for receiving third signals from an external network unit. The signal processing unit is suitable for converting the third signals received from the external network unit into first signals. The audio unit is adapted to convert first signals into audio signals and to reproduce audio signals. The second and third signals are based on a first communication protocol. Communication of the external network units with each other is based on a second communication protocol which represents a network communication protocol. A chairman speech station is included for controlling the communication of the at least one delegate speech station with the network, wherein a communication of the delegate speech station is interrupted and/or enabled.

Thus there is provided a conference speech station for an audio system, which has an audio unit for converting audio signals into first signals, in addition a signal processing unit converts the first signals into second signals and an interface sends the second signals to an external network unit.

A conference speech station of that kind is found to be advantageous insofar as it is less expensive to produce and is also of a simpler configuration as it does not include any network unit which is employed for communication with the conference network.

In accordance with a configuration of the invention the interface is adapted to receive third signals from the external network unit. That therefore permits bidirectional communication between the speech station and a conference network.

In accordance with a further configuration of the invention the signal processing unit is adapted to convert the third signals received from the external network unit into first signals.

In accordance with a further configuration of the invention the audio unit is adapted for converting first signals into audio signals and for reproducing audio signals. That permits a bidirectional communication of audio signals between conference speech stations of a conference system.

In accordance with a preferred configuration of the invention the conference speech station has operating elements for controlling the speech station. A conference-specific control such as for example switching the audio signal transmission on and off can be effected by means of the operating elements.

In accordance with a further configuration of the invention the operating elements are connected to the signal processing unit which converts signals produced by the operating elements into fourth signals and forwards them to the interface. That guarantees transmission of the actuation of the operating elements in or by way of a conference network.

In accordance with a preferred configuration of the invention the conference speech station has a digital signal processing unit and a digital interface. Digital processing of the audio signals and digital communication between the interface and the network unit permits implementation of the speech station with greater degrees of freedom.

In accordance with a configuration of the invention the audio unit has a swan-neck microphone.

The invention also concerns a conference system having a plurality of network units connected by a network and a plurality of the foregoing conference speech stations which are each associated with a respective one of the network units.

In accordance with a further configuration of the invention each of the network units has a specific network identification. That means that the network unit and the conference speech station associated therewith can be uniquely recognized in the network and thus addressed.

In accordance with a further configuration of the invention the conference system has a network server adapted to control the network.

The invention is described in detail hereinafter with reference to the accompanying drawing.

### BRIEF DESCRIPTION OF THE DRAWING

FIG. 1 shows a view illustrating the principle of a conference system according to the invention.

### DESCRIPTION OF THE PREFERRED EMBODIMENT

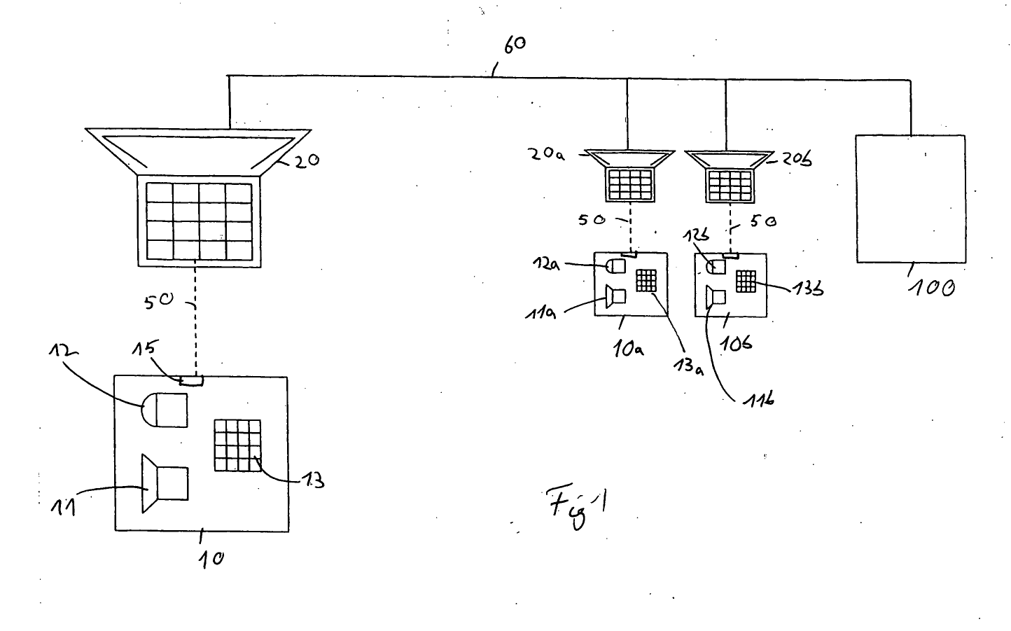

FIG. 1 shows a conference system in accordance with a first embodiment of the invention. The conference system has a network server 100, a network 60 and a plurality of network units 20, 20a, 20b connected to the network 60. A conference speech station 10, 10a, 10b is associated with each network unit 20, 20a, 20b. The conference speech station has a loudspeaker 11, a microphone 12, operating elements 13 and an interface 15.

The network 60 is based on a standard protocol for computer networks such as for example LANs, WLANs or IP-based networks. The communication 50 between the respective network units 20, 20a, 20b and the associated speech stations 10, 10a, 10b is effected for example by way of a standard protocol such as USB, Bluetooth or the like.

The network server 100, the network 60 and the network units 20, 20a, 20b represent a conventional computer network which forms the core of the conference system. The network units 20, 20a, 20b can represent mobile computers such as for example notebooks, PDAs or the like but also desktop computers.

Besides the loudspeakers 11, 11a, 11b, the conference speech stations 10, 10a, 10b each have a microphone 12, 12a, 12b, operating elements 13, 13a, 13b and an interface 15. Thus the conference speech station only has the audio units such as for example the microphone and the loudspeaker, the (optional) operating elements 13 and an interface 15 for communication purposes. As operating elements 13, the speech station can have a button for switching the microphone on/off, buttons for controlling volume, buttons for dialling, buttons for selecting a channel and menu keys.

The microphones 12, 12a, 12b of the conference speech stations 10 are preferably in the form of swan-neck microphones. A signal lamp which indicates speech readiness of the microphone can be mounted on the swan-neck microphone. As an alternative thereto the microphone can be in the form of an interfacial microphone. The conference speech station 10 also has an audio processing unit (not shown) which converts the audio signals recorded by the microphones into digital signals and converts digital signals received over the network 60 into audio signals and outputs them by means of the loudspeaker 11, 11a, 11b. Alternatively to the loudspeaker or additionally a connection for a headphone to the conference speech station can be provided. In that way a delegate can follow the transmitted audio signals by means of a headphone.

Querying of the operating elements 13 of the conference speech stations 10 and transmission of the results arising therefrom are effected by the audio processing unit. The results are also transmitted by means of the interface 15 from the conference speech station 10 to the respective network units 20 which transmit those signals by way of the network 60 to the corresponding network unit or the network server. That therefore provides for transmission of the operation of the operating elements by way of the same network as the transmission of the audio signals of the conference speech station 10.

Optionally the conference speech station has a camera and/or a display so that audio-visual communication is made possible.

Personalization of the corresponding delegate is effected in the network unit 20, that is to say in the notebook or the like. In that way it is possible to save on a microcontroller in the delegate speech station as the personalization functions are implemented by the network units 20.

A choice of the languages of a conference can be effected by means of the network unit 10 automatically in accordance with personalization. As an alternative thereto the choice of the language can also be made manually, in which case that can be effected either directly at the network unit 10 or at the conference speech station 10.

Each of the network units 20, by virtue of the personalization procedure, acquires a network identification, by means of which a network unit can be uniquely identified in the conference system. Thus a direct communication can be made between two delegates or between two conference speech stations insofar as the respective network identification is known. Such a communication can also take place between a delegate and a specific group. Such a communication can be effected audio-visually or by means of text which was inputted by the network units 20. Any data can be transmitted in a communication between delegates.

There can be three different design configurations of conference speech stations in a conference system. The first design configuration of the speech station represents a delegate speech station, by means of which a delegate can follow a conference and optionally by actuation of the on/off switch for the microphone in the speech station can speak to other participants to the conference. A further speech station represents a speech station for interpreters who simultaneously interpret the respective contributions of the delegates into the desired languages. The simultaneously interpreted contributions from the delegates can either be called up by all delegates or the language which can be called up can be previously established in the personalization procedure. While a plurality of delegate speech stations and interpreter speech stations can be provided there is only one single president or chairman speech station. The conference system can be extensively controlled by means of such a speech station. For example a delegate can be interrupted if his contribution extends beyond the talk time allocated to him, for example by the transmission of the audio signals being stopped or interrupted. Alternatively thereto, the chairman speech station can be adapted to switch on that speech station which is associated with the following speaker. The chairman speech station can also be suitable for preventing direct communication between two delegates.

Insofar as the network identification of a network unit is known external messages can also be communicated to the respective speech station.

The network units 20, 20a, 20b can also be suitable for recording or registering the audio signals received from the network 60. If there is speech recognition in the network unit, the communicated audio signal can be converted into text and represented on a display of the network unit 20.

Each conference speech station 10 can have an identification, by means of which the network units can identify the speech stations. The network units can in turn be automatically recognized by the network 60 or automatically by the network server 100.

As soon as a network unit is connected to the network 60 and has been automatically recognized, the required software or the required operating system can be communicated from the network server across the network to the network unit. Connection or registration of the network unit to the network 60 is effected only when personalization has been successfully implemented. That therefore ensures that unauthorized persons do not have any access to the conference network.

Communication of the required software or the operating system enables the station 10 to communicate with the respective network and suitably process the received or communicated data. Accordingly the operating system or the required software does not have to be previously stored in the speech station but can be transmitted beforehand for each individual use and suitably installed.

While the foregoing description and drawings represent the present invention, it will be obvious to those skilled in the art that various changes may be made therein without departing from the true spirit and scope of the present invention.

1-10. (canceled)

11. A conference installation comprising:
a network;
a plurality of network units connected by the network;
at least one delegate speech station which has an audio unit for changing audio signals into first signals;
a signal processing unit for converting first signals into second signals;
an interface for sending the second signals to an external network unit and for receiving third signals from an external network unit;
said signal processing unit being suitable for converting the third signals received from the external network unit into first signals;
said audio unit being adapted to convert first signals into audio signals and to reproduce audio signals;
said second and third signals being based on a first communication protocol;
said communication of the external network units with each other being based on a second communication protocol which represents a network communication protocol; and
a chairman speech station for controlling the communication of the at least one delegate speech station with the network, wherein a communication of the delegate speech station is interrupted and/or enabled.

12. A conference installation according to claim 11 and further comprising operating elements for controlling the delegate speech station.

13. A conference installation according to claim 12 wherein the operating elements are connected to the signal processing unit and wherein the signals produced by the operating elements are converted by the signal processing unit into fourth signals and are forwarded to the interface.

14. A conference installation according to claim 11, wherein the signal processing unit represents a digital signal processing unit and the interface represents a digital interface.

15. A conference installation according to claim 11, wherein the audio unit has a swan-neck microphone.

16. A conference installation according to claim 11, comprising a conference installation control unit for controlling the delegate speech stations connected to a conference installation.

17. A conference installation according to claim 11, wherein the network units each have respective specific network identifications.

18. A conference installation according to clam 11, further r comprising a network server for controlling the network.

19. A conference installation according to claim 11, wherein an operating system upon recognition of the individual delegate speech stations is transmitted to the delegate speech stations during a connection to the network.
